(19) United States
(12) Patent Application Publication
(10) Pub. No.: US 2015/0279260 A1
(43) Pub. Date: Oct. 1, 2015

(54) VEHICLE DISPLAY DEVICE

(71) Applicant: CALSONIC KANSEI CORPORATION, Saitama (JP)

(72) Inventor: Dai Katagiri, Saitama-shi (JP)

(21) Appl. No.: 14/435,594

(22) PCT Filed: Sep. 13, 2013
(86) PCT No.: PCT/JP2013/074908

§ 371 Date: Apr. 14, 2015

(30) Foreign Application Priority Data
Oct. 16, 2012 (JP) 2012-228995

(51) Int. Cl. G09G 3/20; B60Q 3/04; G09G 3/36

(52) U.S. Cl. CPC G09G 3/2003; G09G 3/3607; B60Q 3/048; G09G 2380/10; G09G 2320/0626; G09G 2320/0666

(57) ABSTRACT

Adjustment of display brightness is performed without adjusting brightness of a backlight. An RGB value adjuster adjusts values of RGB components every information stored in each of layers of an information displayer. A display information generator superimposes information in which the values of the RGB components are adjusted and stored in each of the layers and displays the superimposed information on the information displayer.

### TECHNICAL FIELD

The present invention relates to a vehicle display device including a liquid crystal displayer having brightness adjusting function.

### BACKGROUND ART

Various information to represent conditions of a vehicle are displayed in a meter cluster of the vehicle through a vehicle speed meter, an engine tachometer, a water temperature meter, a fuel residual quantity meter, an odometer, a trip meter, various warning lights and so on.

In particular, an example that displays various information on a liquid crystal displayer provided in the meter cluster is recently proposed.

It is disclosed that a brightness adjusting device having brightness adjusting function configured to adjust brightness of displayed information to highly maintain visibility of the displayed information when brightness in a room of the vehicle changes in accordance with date and time and running environment is provided in such a liquid crystal displayer (see, for example, Patent Literature 1).

### RELATED ART

PATENT LITERATURE 1: Japanese Patent Application Publication No. S 62-83232

### SUMMARY OF THE INVENTION

### Technical Problems

In the brightness adjusting device disclosed in Patent Literature 1, the display brightness is adjusted by adjusting brightness of a backlight provided in a displayer.

Therefore, there is a problem in that the brightness adjusting device has a complicated circuit configuration, because a control circuit that controls a current flowing in the backlight is required, and thereby an increased cost is needed for the displayer.

The present invention is made in view of the foregoing circumstances and an object of the present invention is to provide a vehicle display device capable of adjusting display brightness without executing brightness adjustment of the backlight.

### Solution to Problems

A vehicle display device according to an embodiment of the present invention can execute adjustment of display brightness without performing brightness adjustment of a backlight.

That is to say, a vehicle display device according to the present invention includes an information displayer including a plurality of layers configured to be capable of storing RGB components and configured to display a plurality of information relating to operation or condition of a vehicle, stored in each of the plurality of layers and formed by the RGB components, an RGB value adjuster that adjusts display brightness of the information by adjusting values of the RGB components every information stored in each of the plurality of layers, and a display information generator adjusted by the RGB value adjuster and configured to generate information that outputs to the information displayer by superimposing each value of RGB color components stored in the layers.

According to the vehicle display device configured in this way, because the RGB value adjuster adjusts the values of the RGB components every the information stored in each layer of the information displayer, and the information in which the values of the RGB values are thus adjusted and stored in each layer are adapted to be superimposed by the display information generator and displayed on the information displayer, it is possible to easily execute the adjustment of the display brightness of the information displayed on the information displayer by a software only.

### Effects of the Invention

In the vehicle display device according to one embodiment of the present invention, it is possible to acquire advantageous effect capable of executing the adjustment of the display brightness without performing brightness adjustment of the backlight. In addition, there is advantageous effect in that visibility of particular information can be improved because the particular information can be displayed with a bright color tone.

### BRIEF DESCRIPTION OF THE DRAWINGS

FIG. 1 is a block diagram showing a schematic configuration of a first embodiment of a vehicle display device according to the present invention.

FIG. 2A shows a display example of the maximum display brightness of first information displayed on an information displayer of the vehicle display device according to one embodiment of the present invention.

FIG. 2B shows a display example of an intermediate display brightness of the first information displayed on the information displayer of the vehicle display device according to one embodiment of the present invention.

FIG. 2C shows a display example of the minimum display brightness of the first information displayed on the information displayer of the vehicle display device according to one embodiment of the present invention.

FIG. 3 shows an example of information displayed on the information displayer of the vehicle display device according to one embodiment of the present invention, in which, in the state of FIG. 2C, warning display is adapted to be superimposed.

FIG. 4 is an example of a brightness adjustment table T₁ stored in a brightness adjuster in the vehicle display device according to the present invention.

FIG. 5A shows an example of a red color adjustment table that adjusts color tone of red color of a color tone adjustment table stored in a color tone adjuster.

FIG. 5B shows an example of a green color adjustment table that adjusts color tone of green color of the color tone adjustment table stored in the color tone adjuster.

FIG. 5C shows an example of a blue color adjustment table that adjusts color tone of blue color of the color tone adjustment table stored in the color tone adjuster.

FIG. 6 is an example of brightness and color tone which are adjusted in the vehicle display device according to one embodiment of the present invention.

FIG. 7 is a flowchart of processing executed in performing information display in the vehicle display device according to one embodiment of the present invention.

FIG. 8 is a block diagram showing a schematic configuration of a second embodiment of the vehicle display device according to one embodiment of the present invention.

FIG. 9 is a diagram explaining a layer configuration in a case where the information displayer is composed of a plurality of layers in the vehicle display device according to one embodiment of the present invention.

FIG. 10 is a flowchart of processing executed in performing information display in the second embodiment of the vehicle display device according to one embodiment of the present invention.

### EMBODIMENTS OF THE INVENTION

Embodiments of a vehicle display device according to the present invention will be described hereinafter with reference to the accompanying drawings.

### Embodiment 1

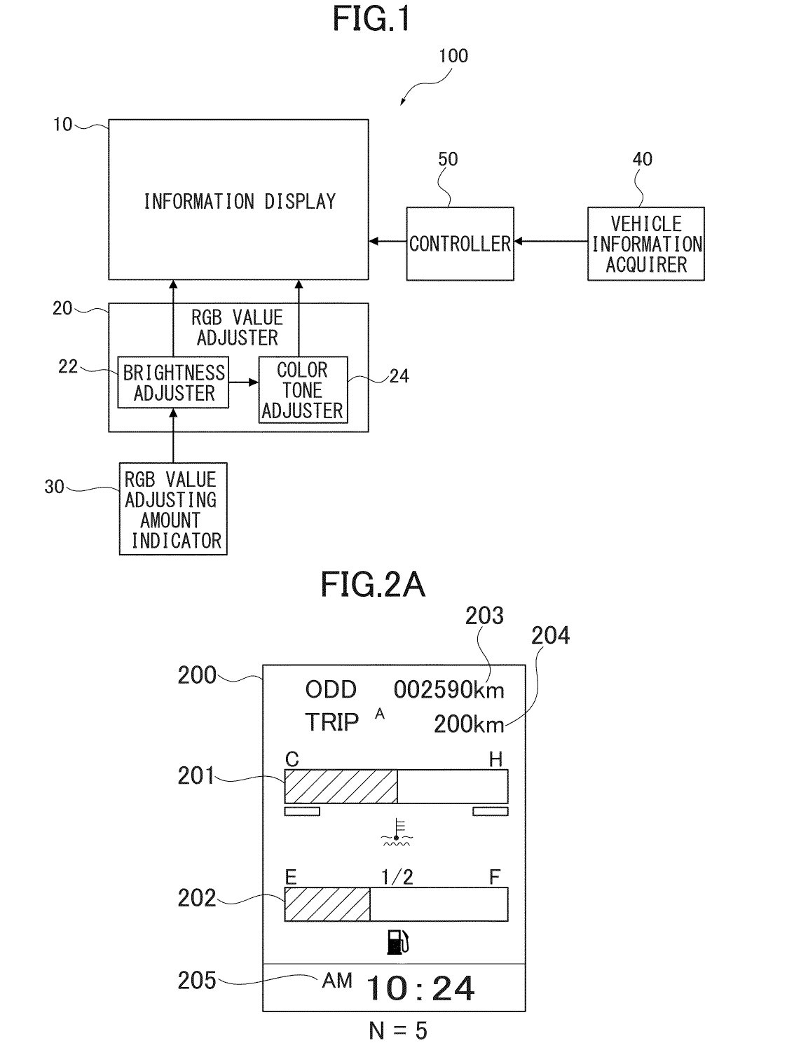

A first embodiment according to the present invention is described hereinafter with reference to the accompanying drawings FIGS. 1 to 7.

The vehicle display device 100 to which the present invention is applied includes an active matrix type color liquid crystal panel, an information displayer 10, an RGB value adjuster 20, an RGB value adjusting amount indicator 30, a vehicle information acquirer 40 and a controller 50 for display output, display release or display position, as shown in FIG. 1. The color liquid crystal panel is provided on a vehicle 5 (not shown) and is provided in a meter cluster. The color liquid crystal panel displays vehicle information such as a fuel residual amount, a water temperature, a running distance and so on, and warning displays such as door ajar-warning, parking brake return failure warning, fuel residual amount warning and so on. The color liquid crystal panel is driven by, for example, TFT (thin transistor). The information displayer 10 is composed of a color liquid crystal monitor comprising a backlight which illuminates the color liquid crystal panel and is capable of storing color components of RGB. The RGB value adjuster adjusts RGB values of information displayed on the information displayer 10. The RGB value adjusting amount indicator indicates an adjustment amount of the RGB values of the information displayed on the information displayer 10. The vehicle information acquirer acquires from the vehicle information necessary to perform display on the information displayer 10. The controller controls a timing that outputs display to the information displayer 10 and a timing that performs display release or display update and performs control of a display position.

In addition, the RGB value adjuster 20 includes a brightness adjuster 22 that adjusts brightness of the information displayed on the information displayer 10 and a color tone adjuster 24 that adjusts a color tone of the information displayed on the information displayer 10.

### [Summary of Display Operation]

Next, a summary of information display operation executed in the embodiment is described.

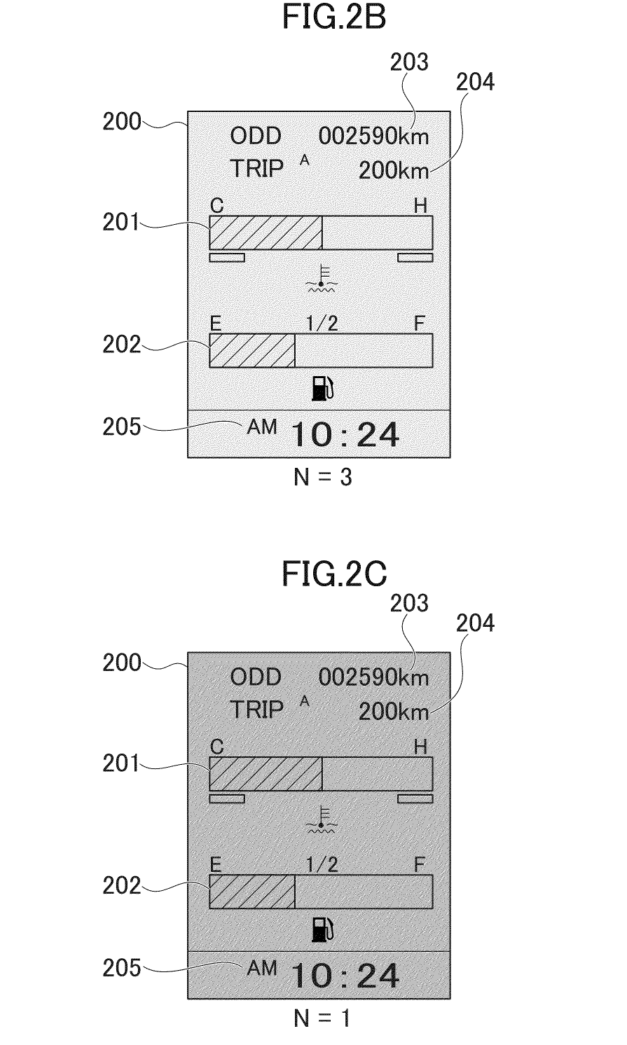

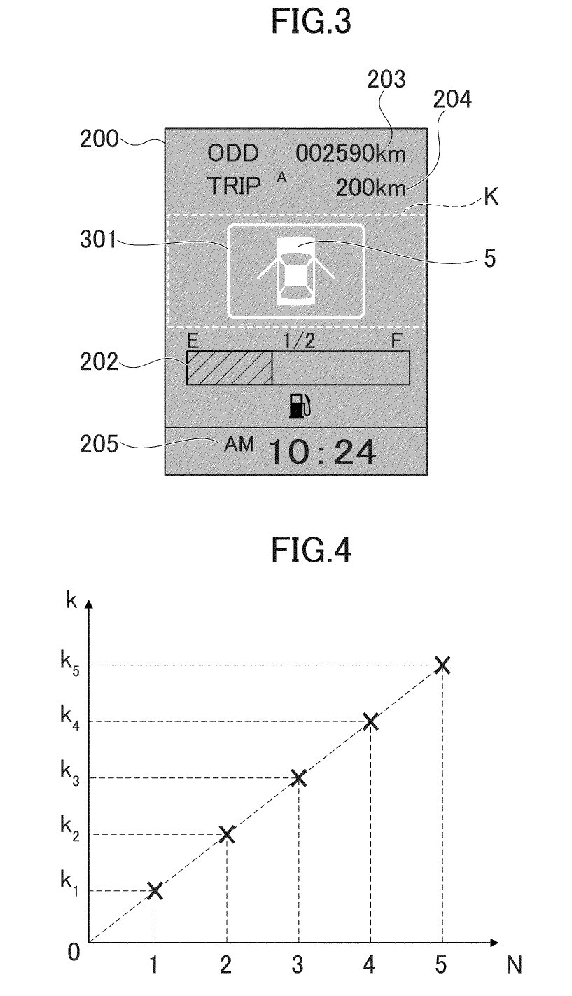

FIG. 2A to FIG. 2C and FIG. 3 each illustrate an example in which the information is displayed on the information displayer 10 provided in the vehicle display device 100 to which the present invention is applied.

A content of the information displayed on the information displayer 10 is first described with reference to FIG. 2. The information displayer 10 is composed of the color liquid crystal monitor and includes a screen 200 on which a water temperature meter 201, a fuel residual amount meter 202, an accumulated mileage meter (odometer) 203, a section distance meter (trip meter) 204 and a clock 205 are each displayed.

Each of the displayed information is displayed with a display brightness adjusted by the RGB value adjuster 20 (see FIG. 1). More specifically, FIG. 2A shows an example displayed with the maximum brightness. FIG. 2B shows an example displayed with an intermediate brightness. FIG. 2C shows an example displayed with the minimum brightness. A method of adjusting the display brightness is described hereinafter.

FIG. 3 shows an example in which, when a display of brightness shown FIG. 2C is executed on the information displayer 10, the vehicle information acquirer 40 detects door ajar of the vehicle 5, and a door ajar-warning display is executed by the operation of the controller 50 for display output, display release and display position. In the example shown in FIG. 3, display of a door ajar-warning icon 301 is overwritten on display of the water temperature meter 201.

At this time, displayed color tone of the door ajar-warning icon 301 is adjusted and displayed in the color tone adjuster 24. A method of adjusting the displayed color tone is described hereinafter.

At the time of displaying the door ajar-warning icon 301, if a driver is aware of door ajar and a door of the vehicle 5 is closed, the vehicle information acquirer 40 does not detect the door ajar. Therefore, the display of the door ajar-warning icon 301 is turned off by the operation of the controller 50 for display output, display release and display position and the information displayer 10 returns to the display shown in FIG. 2C.

### [Summary of Brightness Adjustment]

Next, the method of adjusting the display brightness described in FIGS. 2A to 2C is described with reference to FIG. 4.

In general, the display brightness is adjusted by adjusting brightness of a backlight of a color liquid crystal monitor consisting the information displayer 10 in accordance with an operation amount of the RGB value adjusting amount indicator (light control switch) 30 (see FIG. 1) provided on the vehicle 5.

However, in the embodiment, the adjustment of the display brightness in the information displayer 10 is executed by adjusting RGB values of information output to the information displayer without adjusting the brightness of the backlight.

That is to say, when the driver first operates the RGB value adjusting amount indicator (light control switch) 30 (see FIG. 1) provided on the vehicle 5, the light control switch 30 indicates the number of light control steps to the RGB value adjuster 20 in accordance with the operation of the driver. In the embodiment, the number N of light control steps is five steps, the number N=1 of light control steps indicates the minimum brightness and the number N=5 of light control steps indicate the maximum brightness.

Next, the number N of light control steps indicated by the RGB value adjusting amount indicator (light control switch) 30 is converted into a coefficient kᵢ (0≦kᵢ≦1) used in performing the brightness by a brightness adjustment table T₁ which is shown in FIG. 4 and stored in the brightness adjuster 22.

More specifically, a coefficient k₁ is selected when the number N of light control steps is 1, a coefficient k₂ is selected when the number N of light control steps is 2. Hereinafter, similarly, the coefficient kᵢ is selected when the number N of light control steps is i.

By using the coefficient kᵢ selected in this way, a brightness value of information output from the information displayer 10 is adjusted.

Here, brightness value of information displayed on the information displayer 10 is represented by RGB values. That is to say, a red color component of the information is R, a green color component of the information is G and a blue color component of the information is B, and hence the RGB (R, G, and B) values of the information are displayed. In addition, the brightness is small as the RGB values are small.

At this time, each of the RGB (R, G, and B) values of the information is multiplied by the coefficient kᵢ as previously set and the RGB values of the information are adjusted to be (kᵢ R, kᵢ G, and kᵢ B). Here, kᵢ is (0≦kᵢ≦1).

The RGB values as thus adjusted is output to the information displayer 10.

The operation of multiplying the brightness values of the information by the coefficient kᵢ as described above has the same effect as an operation superimposing a smoke film having a transmittance similar to the coefficient kᵢ on the screen of the information displayer 10 after information to be displayed is stored in the information displayer 10.

Consequently, the adjustment of the RGB values makes it possible to adjust the display brightness of the information without adjusting the brightness of the backlight of the color crystal monitor consisting the information displayer 10.

The foregoing example equally adjusts the brightness of all the information (the water temperature meter 201, the fuel residual amount meter 202, the accumulated mileage meter (odometer) 203, the section distance meter (trip meter) 204 and the clock 205). However, it is possible to execute brightness adjustment every information displayed on the information displayer 10. In this case, by preparing a separate brightness adjustment table Tᵢ to each of the water temperature meter 201, the fuel residual amount meter 202, the accumulated mileage meter (odometer) 203, the section distance meter (trip meter) 204 and the clock 205, a different coefficient kᵢ may be set referring to each brightness adjustment table Tᵢ in accordance with the number N of brightness steps.

### [Description of Summary of Color Tone Adjustment]

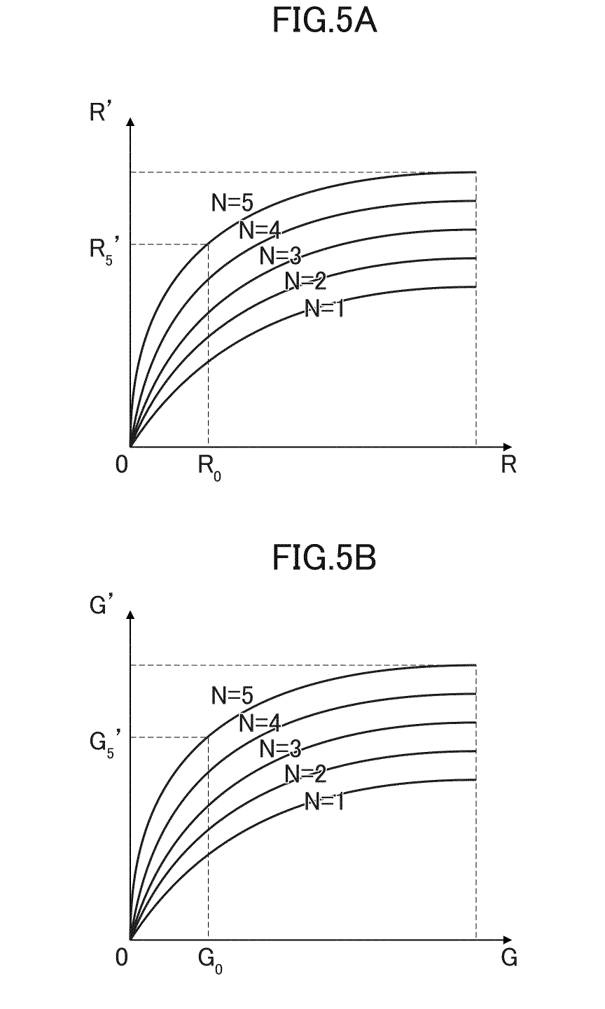

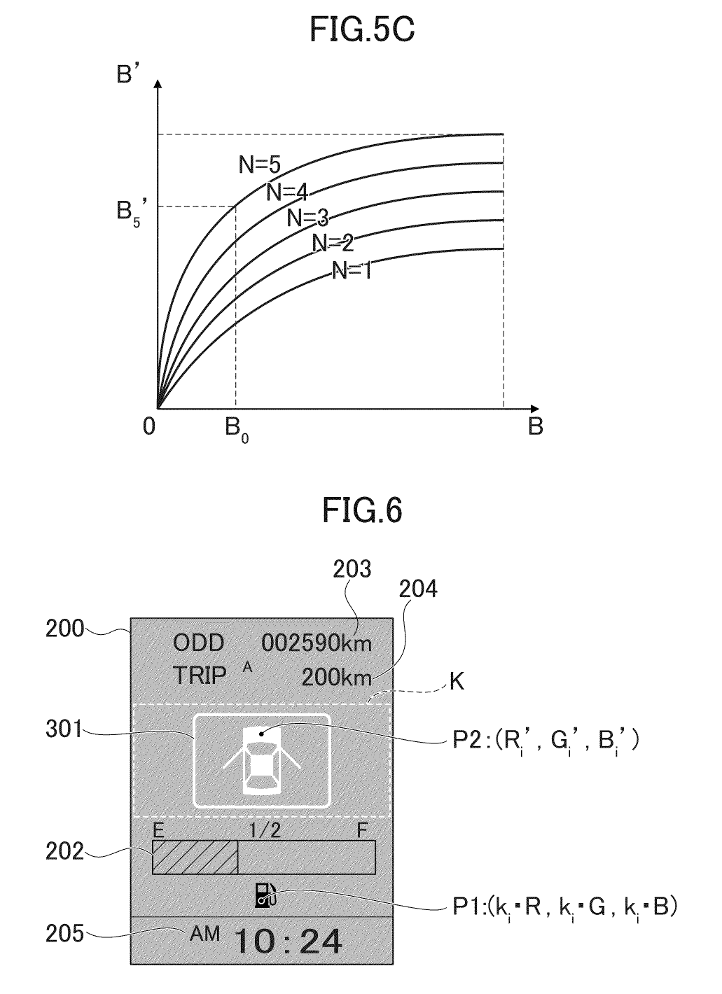

When superimposing other information (the door ajar-warning icon 301 in the embodiment) on the information in which the brightness is adjusted, by adjusting color tone of superimposed information, it is possible to improve more visibility of the superimposed information than the other information. A method of adjusting the color tone of the display is described with reference to FIGS. 5A to 5C. The adjustment of the color tone of the display is executed in conjunction with the adjustment of the display brightness by operating the RGB value adjusting amount indicator (light control switch) 30 (see FIG. 1) placed in the vehicle 5 by the driver.

FIGS. 5A to 5C show an example of a color tone adjustment table T₂ stored in the color tone adjuster 24. FIG. 5A shows an example of a red color adjustment table T_{2R} that adjusts color tone of red color. FIG. 5B shows an example of a green color adjustment table T_{2G} that adjusts color tone of green color. FIG. 5C shows an example of a blue color adjustment table T_{2B} that adjusts color tone of blue color.

Here, a content of the red color adjustment table T_{2R} as shown in FIG. 5A is described.

A horizontal axis in FIG. 5A represents a magnification of a red color component R of information displayed on the information displayer 10. A vertical axis in FIG. 5A represents red color tone R′ to be adjusted. An adjusting amount of the color tone is defined in accordance with the number N (N=1 to 5) of light control steps as mentioned above.

In the example of FIG. 5A, an adjustment to more brighten the color tone of red color is made. In other words, an adjustment is set such that the red color component R has higher lightness and/or chroma. For example, if color tone of the original red color is Ro and the number N of light control steps is 5, it is represented that the color tone of the red color is adjusted to be R₅′.

Additionally, in the examples shown in FIGS. 5B and 5C, it is noted that color tones of the green color component G and the blue color component B also are adjusted in accordance with a similar characteristic to that of the red color component R.

That is to say, it is represented that if the number N of light control steps is 5 and color tone of the original green color is G₀, the color tone of the green color is adjusted to be G₅′ and if color tone of the original blue color is B₀, the color tone of the blue color is adjusted to be B₅′.

In this way, the color tone adjustment table T₂ shown in FIGS. 5A to 5C is applied to an inner portion of an area (rectangular area K in FIG. 3) including the door ajar-warning icon 301. Here, a color tone of an area other than the icon of the door ajar-warning icon 301 is adjusted to be (R′, G′, B′)=(0, 0, 0).

In this way, the information having the adjusted color tone is overwritten on a predetermined position of the information displayer 10 by the operation of the controller 50 for display output, display release and display position. That is to say, the rectangular area K (see FIG. 3) to which the color tone adjustment table T₂ is applied is overwritten on a position obscuring the predetermined display of the water temperature meter 201. Here, a drawn position of the rectangular area K is preset and stored in the controller 50 for display output, display release and display position.

The information generated in this way is displayed on the screen 200 of the color liquid crystal monitor placed in the meter cluster. At this time, because the door ajar-warning icon 301 is adjusted in color tone to be a brighter color tone, the generated information has a higher visibility than the other information which is adjusted to a low brightness and hence the fact of information attracting attention can be communicated to the driver immediately.

### [Description of Operation]

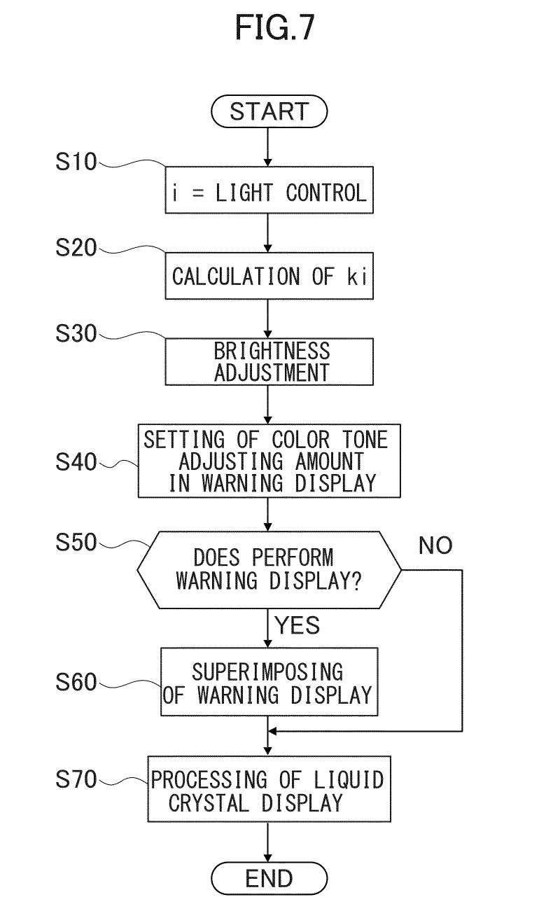

Next, a series of flows of the embodiment are described with reference to a flow chart shown in FIG. 7.

### (Step S10)

The operation of the RGB value adjusting amount indicator 30 which is the light control switch by the driver makes it possible to set the number N of light control steps. The set number N of light control steps is sent to the brightness adjuster 22.

### (Step S 20)

Next, in the brightness adjuster 22, the coefficient kᵢ to calculate the display brightness of the information displayed on the information displayer 10 is read out from the brightness adjustment table T₁ based on a value of the number N of light control steps.

### (Step S 30)

Thus, the brightness adjustment is executed in the brightness adjuster 22. The brightness adjustment is acquired by multiplying the RGB values of the information output to the information displayer 10 by the previously set coefficient kᵢ. If the RGB values of the information output to the information displayer 10 are (R, G, B), the adjusted brightness values are (kᵢR, kᵢG, kᵢB).

### (Step S 40)

Next, in the color tone adjuster 24, the color tone adjusting amount of the door jar warning icon 301 which is the warning display displayed on the information displayer 10 is set. The color tone adjustment is executed by use of the color tone adjustment table T₂ stored in color tone adjuster 24 shown in FIGS. 5A to 5C as described above. Meanwhile, the color tone adjustment is concretely executed by applying the color tone adjusting amount set by the color tone adjuster 24 to the inner portion of the rectangular area K including the door ajar-warning icon 301 output to the information displayer 10.

### (Step S 50)

In the controller 50 for display output, display release and display position, whether the warning display is executed is determined. The determination is performed by analyzing the vehicle information such as a door opening signal indicating that either door of the vehicle 5 is opened or fuel residual amount signal indicating that the fuel residual amount of the vehicle 5 is lesser than a predetermined value, and the vehicle information is acquired in the vehicle information acquirer 40. When it is determined that warning is needed, such as when either door of the vehicle 5 is opened by the door opening signal or when the fuel residual amount of the vehicle 5 is lesser than the predetermined value by the fuel residual amount signal, the process goes to step S60, when it is determined that the warning is not needed, the process goes to step S70.

### (Step S 60)

For example, in step S50, when it is determined that either door of the vehicle 5 is opened, a warning display is executed by causing the display of the door ajar-warning icon 301 to interrupt. At this time, in step 60, the door ajar-warning icon 301 in which the color tone is adjusted in step S40 is overwritten on the information in which the brightness is adjusted in step S30, in the information displayer 10. The concrete method of overwriting is as described above.

### (Step S 70)

The information in which the overwriting of the door ajar-warning icon 301 is performed in step S60 is illuminated by a backlight from a back surface of the screen and displayed on the screen 200 of the color liquid crystal monitor provided in the meter cluster.

As described above, in the vehicle display device 100 according to Embodiment 1, because the RGB value adjuster 20 adjusts the values of the RGB components of the information displayed on the information displayer 10 every the information displayed on the information displayer 10, the adjustment of the display brightness of the information displayed on the information displayer 10 can easily be executed by only a software. In addition, because the RGB value adjuster 20 adjusts the values of the RGB components of the door ajar-warning icon 301 which is necessary to further attract attention of the driver to be higher values of the RGB components than that of other information in brightness and/or chroma, it is possible to improve particular information more than other information and securely attract attention of the driver.

Moreover, in the vehicle display device 100 according to Embodiment 1, because the RGB value adjuster 20 adjusts the values of the RGB components of all or a part of the information displayed on the information displayer 10 in conjunction with light control of a lighting tool of the vehicle 5, it is possible to easily execute the adjustment operation of the display brightness of the information displayer 10 of the vehicle display device 100.

Furthermore, in the vehicle display device 100 according to Embodiment 1, because the RGB value adjuster 20 performs the adjustment of the display brightness based on the brightness adjustment table T₁ in which a relationship between the values of the RGB components as input and the values of the RGB components as output is described, it is possible to adjust the display brightness by only the software, thereby enabling executing the adjustment of the display brightness without performing the bright adjustment of the backlight.

In addition, in Embodiment 1, although the example in which the color tone of the door ajar-warning icon 301 is adjusted to be brighter has been described, the method of adjusting the color tone is not limited to this. In other words, even when the display color tone of the door ajar-warning icon 301 always fixes to the brightest color tone, it is possible to achieve an intended object in which the visibility of the door ajar-warning icon 301 is improved.

In addition, in Embodiment 1, although the example in which the door ajar-warning icon 301 is overwritten on the information in which the brightness is adjusted has been described, the overwritten display is not limited to one. More specifically, it is possible to, in an area which does not overlap with the rectangular area K displaying the door ajar-warning icon 301, output, for example, the parking brake return failure icon, overwrite each of the door ajar-warning icon 301 and the parking brake return failure icon on the information in which the brightness is adjusted, and display them simultaneously.

### Embodiment 2

A second embodiment according to the present invention is described with reference to FIG. 2A to FIG. 6 and FIG. 8 to FIG. 10.

The embodiment is an example in which the information displayer of the vehicle display device is composed of an information displayer 60 comprising a plurality of layers capable of storing the RGB components.

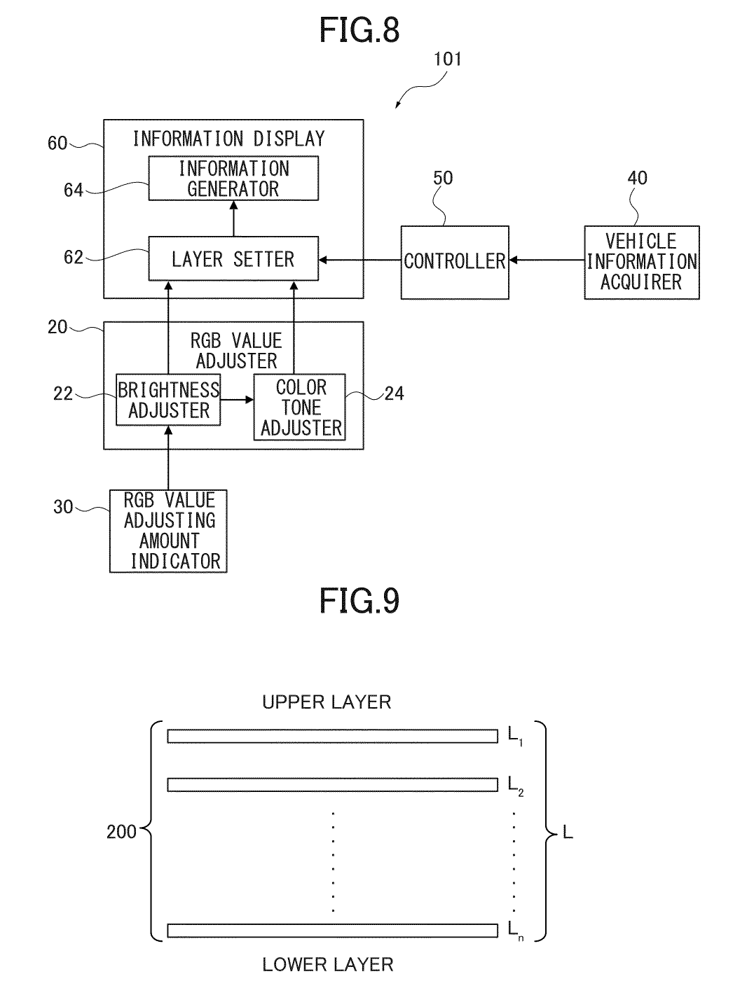

That is to say, a vehicle display device 101 to which the present invention is applied includes an active matrix type color liquid crystal panel, the information displayer 10, the RGB value adjuster 20, the RGB value adjusting amount indicator 30, the vehicle information acquirer 40 and the controller 50 for display output, display release or display position, as shown in FIG. 8. The color liquid crystal panel is provided on the vehicle 5 (not shown) and is provided in the meter cluster. The color liquid crystal panel displays vehicle information such as the fuel residual amount, the water temperature, the running distance and so on, and warning displays such as door ajar-warning, parking brake return failure warning, fuel residual amount warning and so on. The color liquid crystal panel is driven by, for example, TFT (thin transistor). The information displayer 60 is composed of a color liquid crystal monitor comprising a backlight which illuminates the color liquid crystal panel and includes a plurality of layers capable of storing color components of RGB. The RGB value adjuster adjusts brightness and color tone of the information displayed on the information displayer 60. The RGB value adjusting amount indicator indicates adjustment amount of the RGB values of the information displayed on the information displayer 60. The vehicle information acquirer acquires from the vehicle information necessary to perform display on the information displayer 60. The controller controls a timing that outputs the display to the information displayer 10 and a timing that performs display release or display update and performs control of a display position.

The information displayer 60 further includes a layer setter 62 that outputs information in which brightness and color tone are adjusted to each of the plurality of layers and a display information generator 64 that generates information displayed on the information displayer 60.

The RGB value adjuster 20 further includes the brightness adjuster 22 that adjusts brightness of the information displayed on the information displayer 60 and the color tone adjuster 24 that adjusts color tone of the information displayed on the information displayer 60

Operation of the vehicle display device 101 is approximately similar to that of the vehicle display device 100 described in Embodiment 1, and therefore a difference therebetween is described hereinafter.

### [Description of Summary of Display Operation]

A summary of operation of information display executed in the present embodiment is described.

FIGS. 2A to 2C and FIG. 3 illustrate the example of the information displayed on the information displayer 60 in the vehicle display device 100 to which the present invention is applied.

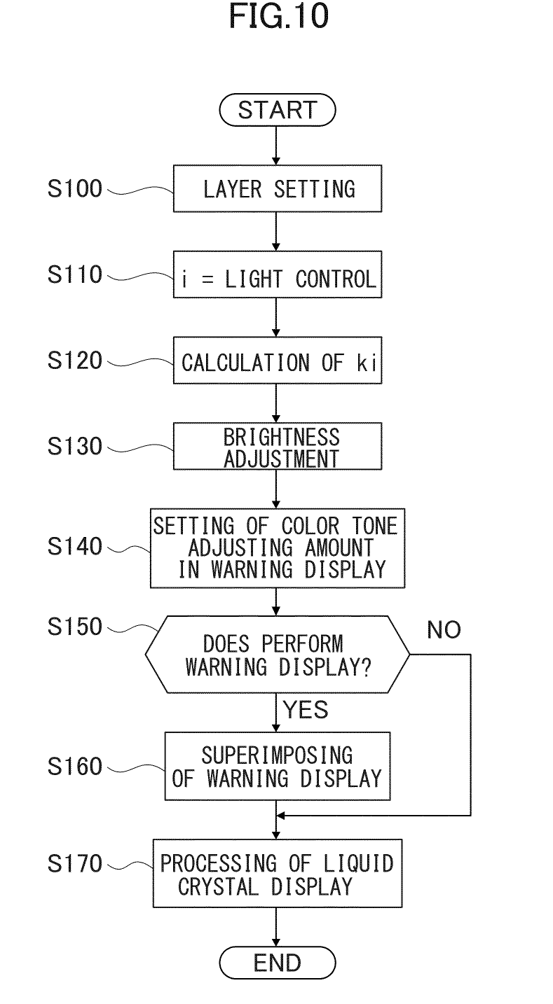

In the present embodiment, the screen 200 of the color liquid crystal monitor constituting the information displayer 60 is composed of the plurality of layers L (L₁, L₂, . . . , Lₐ), as shown in FIG. 9. Thus, the information shown in FIGS. 2A to 2C is output to the lowermost layer Lₙ, the door ajar-warning icon 301 shown in FIG. 3 is output to a layer (for example, the layer L₁) other than the lowermost layer Lₙ.

The information output to the lowermost layer Lₙ is displayed with the display brightness adjusted by the brightness adjuster 22 (see FIG. 8). More specifically, FIG. 2A illustrates an example displayed with the maximum brightness, FIG. 2B illustrates an example displayed with an intermediate brightness, and FIG. 2C illustrates an example displayed with the minimum brightness. The method of adjusting the display brightness is as described in Embodiment 1.

FIG. 3 illustrates the example in which the vehicle information acquirer 40 detects the door jar of the vehicle 5 and the door ajar-warning display is executed by the operation of the controller 50 for display output, display release or display position, when the display in FIG. 2C is executed in the information displayer 60. In the example shown in FIG. 3, the door ajar-warning icon 301 is overwritten on the display of the water temperature meter 201 to be displayed.

At this time, the door ajar-warning icon 301 is adjusted in display color tone in the color tone adjuster 24 and displayed. The method of adjusting the display color tone is described in Embodiment 1.

When the door ajar-warning icon 301 is displayed, if the driver is aware of door ajar and the door of the vehicle 5 is closed, because the vehicle information acquirer 40 does not detect, the display of the door ajar-warning icon 301 is turned off by the operation of the controller 50 for display output, display release or display position, and the information displayer 60 is returned to the state of FIG. 2C.

### [Description of Summary of Brightness Adjustment]

The adjustment of the display brightness of the information displayed on the information displayer 60 in the present embodiment is executed in the bright adjuster 22. The method of adjusting the brightness is as described in Embodiment 1, therefore a further description is omitted.

Thus, the information in which the brightness is adjusted in the brightness adjuster 22 is output to the lowermost layer Lₙ of the plurality of layers L constituting the screen 200 of the color liquid crystal monitor by the operation of the layer setter 62.

### [Description of Summary of Color Tone]

The adjustment of the color tone of the information displayed on the information displayer 60 in the present embodiment is executed in the color tone adjuster 24. The method of adjusting the color tone is as described in Embodiment 1, therefore, a further description is omitted.

Thus, the information in which the color tone is adjusted in the color tone adjuster 24 is output to a predetermined layer, for example, the layer L₁ other than the lowermost layer Lₙ of the plurality of layers L constituting the screen 200 of the color liquid crystal monitor by the operation of the layer setter 62. At this time, position coordinate of each apex of the rectangular area K (see FIG. 3) to which the color tone adjustment table T₂ is applied is stored in the layer setter 12.

### [Description of Summary of Display Information Generation]

Next, an explanation is made of a summary of processing of generating the information displayed on the information displayer 60 by superimposing the information in which the brightness is adjusted and the door ajar-warning icon 301 in which the color tone is adjusted.

The processing is executed in the display information generator 64. Thus, the door ajar-warning icon 301 which is the adjusted color tone information output to, a layer, for example, the layer L₁ other than the lowermost layer is superimposed on the information which is the adjusted brightness information output to the lowermost layer Lₙ.

Concretely, the information in which the color tone is adjusted and which is output to the layer L₁ is superimposed on the information in which the brightness is adjusted and which is output to the lowermost layer Ln, in the inner portion of the rectangular area K which is the range of the color tone adjustment. In other words, in the inner portion of the rectangular area K, the display of the water temperature meter 201 is masked (overwritten) by the door ajar-warning icon 301 in which the color tone is adjusted, thereby the display of the water temperature meter 201 is superimposed to be invisible.

A manner of superimposing the information output to the lowermost layer Lₙ and the layer L₁ other than the lowermost layer is described with reference to FIG. 6. FIG. 6 is the drawing used in the description of the first embodiment, but the form of the information displayed on the information displayer 60 is the same as of that of the information displayed on the information displayer 10. Therefore, a description is made with reference to FIG. 6.

That is to say, the brightness adjustment as mentioned above is applied to the information output to the lowermost layer Lₙ. For example, in FIG. 6, if the RGB values (R, G, B) are stored in point P1 constituting an icon that displays the fuel residual amount meter 202 before the brightness is adjusted, the point P1 is adjusted in brightness, the RGB values have (kᵢR, kᵢG, kᵢB) (1≦i≦5).

In addition, if the RGB values (R, G, B) are stored in point P2 constituting the door ajar-warning icon 301 before the color tone is adjusted, the point P2 is adjusted in color tone, the RGB values are (Rᵢ′, Gᵢ′, Bᵢ′) (1≦i≦5). The rectangular area K including the door ajar-warning icon 301 masks the display of the water temperature meter 201 (see FIG. 2C) output to the lowermost layer Lₙ. As a result, the display of the water temperature meter 201 is invisible.

Here, in the present embodiment, the information (door ajar-warning icon 301) in which the color tone is adjusted is output to the layer L₁. However, this can superimpose information by the same method even if a plurality of information in which the color tone is adjusted is output to a layer other than the lowermost layer Lₙ and the layer L₁. In other words, information in a layer of upper level is superimposed on information in a lower layer than the upper layer to cover.

In this way, the superimposed information in the display information generator 64 is displayed on the screen 200 of the color liquid crystal monitor provided in the meter cluster. At this time, because the color tone of the door ajar-warning icon 301 to be more bright color tone, the information output to the lowermost layer Ln has a high visibility and information that should attract attention can be communicated to the driver immediately.

### [Description of Operation]

Next, a series of flows in the present embodiment is described with reference to a flow chart of FIG. 10.

### (Step S100)

First, in the layer setter 62, a layer that outputs the information displayed on the information displayer 60, of the plurality of layers L constituting the screen 200 of the color liquid crystal monitor is set. In case of the present embodiment, as a layer that displays the water temperature meter 201, the fuel residual amount meter 202, the accumulated mileage meter (odometer) 203, the section distance meter (trip meter) 204 and the clock 205, the lowermost layer Ln is set. As a layer that displays door ajar-warning icon 301, the layer L₁ is set.

### (Step S110)

Next, the driver operates the RGB value adjusting amount indicator 30 which the light control switch, thereby the number N of light control steps is set. The set number N of light control steps is sent to the brightness adjuster 22.

### (Step S120)

Next, in the brightness adjuster 22, a coefficient kᵢ to calculate display brightness of the information displayed on the information displayer 60 based on a value of the number N of light control steps is read out from the brightness adjustment table T₁.

### (Step S130)

Thus, adjustment of the brightness is executed in the brightness adjuster 22. The brightness adjustment is executed by multiplying values of RGB components of the information output to the lowermost layer Lₙ by the previously set coefficient kᵢ. More specifically, if the values of the RGB components of the information output to the lowermost layer Ln are (R, G, B), the adjusted brightness values are (kᵢR, kᵢG, kᵢB).

### (Step S140)

Next, in the color tone adjuster 24, a color tone adjustment amount of the door ajar-warning icon 301 which is a warning display displayed on the information displayer 60 is set. The color tone adjustment is executed by use of the color tone adjustment table T₂ stored in the color tone adjuster 24 shown in FIGS. 5A to 5C as described above. In addition, concrete color tone adjustment is executed by applying the color tone adjustment amount set in the color tone adjuster 24 to the information output to the inner portion of the rectangular area K including the door ajar-warning icon 301 output to the layer L₁.

### (Step S150)

In the controller 50 for display output, display release or display position, whether the warning display is executed is determined. The determination is executed by analyzing vehicle information such as a door opening signal indicating that any door of the vehicle 5 opens or a fuel residual amount signal indicating that a fuel residual amount of the vehicle 5 is lower than a predetermined value and so on. When it is determined that warning is needed, such as when it is determined that any door of the vehicle 5 opens by the door opening signal, or the fuel residual amount of the vehicle 5 is lower than a predetermined value by the fuel residual amount signal, the process goes to step S160, and when the warning is not needed, the process goes to step S170.

### (Step S160)

For example, in step S150, when it is determined that any door of the vehicle 5 opens, the warning display is executed by the door ajar-warning icon 301 by interrupt display of the door ajar-warning icon 301. Therefore, in step 160, in the display information generator 14, the door ajar-warning icon 301 in which the color tone is adjusted in step S140 is superimposed on the information which is output to the lowermost layer Lₙ and in which the brightness is adjusted in step S130. The concrete superimposing method is as described above.

### (Step S170)

The information superimposed in step S160 is illuminated with the backlight from the back surface and is displayed on the screen 200 of the color liquid crystal monitor provided in the meter cluster.

As described above, in the vehicle display device 101 according to Embodiment 2, because the RGB value adjuster 20 adjusts the values of the RGB components every the information stored in each layer of the information displayer 60, thereby the values of the RGB components are thus adjusted, and the information stored in each layer is adapted to be superimposed by the display information generator 64 to be displayed on the information displayer 60, it is possible to easily execute the adjustment of the display brightness of the information displayed on the information displayer 60 by the software only.

Moreover, in the vehicle display device 101 according to Embodiment 2, because the values of the RGB components of the information stored in the layer of the more upper position masks the information stored in the layer of the lower position at the same position as that of the foregoing information, the display information generator 64, the information stored in the layer at the upper position is rewritten on the information stored in the layer at the lower position, whereby enabling executing the interrupt display easily.

Also, in the vehicle display device 101 according to Embodiment 2, because the RGB value adjuster 20 adjusts the values of the RGB components of a part or all of the information stored in the lowermost layer Lₙ of the information displayer 60 in conjunction with the light control of the lighting tool of the vehicle 5, it is possible to easily perform the adjustment operation of the display brightness of the vehicle display device 101.

Moreover, in the vehicle display device 101 according to Embodiment 2, because the RGB value adjuster 20 executes the adjustment of the display brightness based on the brightness adjustment table T₁ in which the relationship between the values of the input RGB components and the values of the output RGB components is described, it is possible to adjust the display brightness by the software only, thereby enabling adjusting the display brightness without adjusting the brightness of the backlight.

Furthermore, in the vehicle display device 101 according to Embodiment 2, because the RGB value adjuster 20 adjusts the values of the RGB components of the door ajar-warning icon 301 to be values of RGB components higher than the values of the RGB components of the information output to the lowermost layer Ln in brightness and/or chroma, it is possible to improve visibility of the door ajar warning icon 301, more than that of other information.

In addition, in the vehicle display device 101 according to Embodiment 2, because the door ajar-warning icon 301 necessary to further attract attention to the driver is displayed with visibility higher than that of the information output to the lowermost layer Lₙ, it is possible to securely attract the attention of the driver when an event where attention should be attracted is generated.

Meanwhile, in the foregoing embodiments, the brightness adjustment is executed by multiplying the information output to the lowermost layer Lₙ by the coefficient kᵢ. However, by use of one layer of the plurality of layers L included in the information displayer 60 as a smoke layer having a transmittance similar to the coefficient kᵢ, even if the brightness of the information displayed on the information displayer 60 is calculated by multiplying the information output to the lowermost layer Lₙ by the coefficient kᵢ set as the transmittance of the smoke layer in the display information generator 14, it is possible to acquire the same operational effect as in the embodiments as described above.

In addition, in the foregoing embodiments, the information in which the brightness is adjusted is output to the lowermost layer Ln of the information displayer 60, but the information may be output to the layer other than the lowermost layer Ln. However, in this case, the method of process superimposing the information output to the plurality of layers, which is executed in the display information generator 64 is adequately changed. That is to say, in case of superimposing the information in the layer lower than the information in which the brightness is adjusted, by clearing the information in an area at a position corresponding to the superimposing information in the information in which the brightness is adjusted, the superimposing of the information is executed such that information in a further lower layer appears through the cleared information.

In addition, in the foregoing embodiments, the example in which the door ajar-warning icon 301 is superimposed on the information in which the brightness is adjusted and configured to be displayed has been described. However, the superimposed display is not limited to one. More specifically, by outputting, for example, the parking brake return failure icon in an area which does not overlap with the rectangular area K displaying the door ajar-warning icon 301 in the same layer as the layer outputting the door ajar-warning icon 301 or other layer and superimposing each of the door ajar-warning icon 301 and the parking brake return failure icon on the lowermost layer in which the brightness is adjusted, it, also, is possible to display simultaneously them.

Furthermore, in the foregoing embodiments, although it has been described that the information displayer 60 is composed of the color liquid crystal monitor, the information displayer is not limited to this. Even if any display devices such as an EL (electroluminescence) panel, fluorescent display tube, and so on are used, the same effect can be acquired.

As described above, although the embodiments according to the present invention have been described with reference to the drawings, because the embodiments are mere examples, the present invention is not limited to only the configurations in the embodiments. Even if modifications and so on are made in a scope without departing the gist of the present invention, they are included in the scope of the present invention. In addition, for example, if a plurality of configurations is included in each embodiment, possible combinations of the configurations are, of course, included in the embodiments, even if there is no description. Moreover, if some embodiments or modifications are shown, possible combinations thereof can, of course, be included in the present invention even if there is no description in particular. A configuration shown the drawings can, of course, be included in the present invention even if there is no description in particular. Furthermore, words, “and so on” are used to include similar parts in meaning. Also, if there are terms, “approximately”, “about”, “degree” and so on, they are used to include a commonly recognized range or accuracy in meaning.

### CROSS REFERENCE TO RELATED APPLICATION

This application is based upon and claims the benefit of priority to Japanese Patent Application No. 2012-228995 filed on Oct. 16, 2012, the entire disclosures of which are incorporated herein by reference.

### EXPLANATION OF REFERENCE NUMERALS

101 vehicle display device
60 information displayer
62 layer setter
64 display information generator
20 RGB value adjuster
22 brightness adjuster
24 tone adjuster
30 RGB value adjusting amount indicator
40 vehicle information acquirer
50 controller for display output, display release or display position

1. A vehicle display device comprising:
an information displayer including a plurality of layers configured to store RGB components and configured to display a plurality of information relating to operation or condition of a vehicle, stored in each of the plurality of layers and formed by the RGB components;
an RGB value adjuster that adjusts display brightness of the information by adjusting values of the RGB components every information stored in each of the plurality of layers; and
a display information generator adjusted by the RGB value adjuster and configured to generate information outputting to the information displayer by superimposing each value of RGB color components stored in the layers.

2. The vehicle display device according to claim 1, wherein
the display information generator masks, by RGB components of information stored in a layer at a more upper position, information stored at the same position as that of the information in a layer at a position lower than the layer at the upper position to superimpose the information respectively stored in the plurality of layers.

3. The vehicle display device according to claim 2, wherein
the RGB value adjuster adjusts values of RGB components of a part or all of information stored in a lowermost layer of the information displayer in conjunction with light control of a light tool of the vehicle to adjust display brightness of the part or all of the information.

4. The vehicle display device according to claim 3, wherein
the RGB value adjuster executes adjustment of display brightness of the information based on a table which is previously prepared every the information and in which a relationship between values of input RGB components and values of output RGB components is stored.

5. The vehicle display device according to claim 4, wherein
the RGB value adjuster for particular information adjusts values of RGB components of the particular information to have values of RGB components higher than other information in brightness and/or chroma.

6. The vehicle display device according to claim 5, wherein
the particular information is information necessary to attract attention of a driver more than other information.

7. A vehicle display device comprising:
an information displayer that displays a plurality of information including RGB components relating to operation or condition of a vehicle; and
an RGB value adjuster adjusts values of the RGB components of the information every information displayed on the information displayer to adjust display brightness of the information,
wherein values of RGB components of particular information necessary to further attract attention of a driver are adjusted to have values of RGB components higher than other information in brightness and/or chroma.

8. The vehicle display device according to claim 7, wherein
the RGB value adjuster adjusts values of RGB components of a part or all of information stored in a lowermost layer of the information displayer in conjunction with light control of a light tool of the vehicle to adjust display brightness of the part or all of the information.

9. The vehicle display device according to claim 8, wherein
the RGB value adjuster adjusts display brightness of the information based on a table which is previously prepared every the information and in which a relationship between values of input RGB components and values of output RGB components is stored.
